(19) United States
(12) Patent Application Publication
(10) Pub. No.: US 2007/0042702 A1
(43) Pub. Date: Feb. 22, 2007

(54) Medical mini-environment device

(75) Inventors: Ming-Shan Jeng, Hsinchu (TW); Yan-Ching Lee, Hsinchu (TW); Ya-Wen Chou, Hsinchu (TW); Chao-Ho Lan, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/303,933

(22) Filed: Dec. 19, 2005

(30) Foreign Application Priority Data
Aug. 16, 2005 (TW) 94127812

(51) Int. Cl. B01L 1/04

(52) U.S. Cl. 454/187

(57) ABSTRACT

A ventilation apparatus for forming a sterile medical area mainly includes an operation module for ventilating the air. The apparatus for ensuring the air cleanliness includes a filtering unit for filtering dusts and particles in the air and a sterilizing unit for eliminating micro organisms. The clean and sterilized air is sent into the medical area via an air outlet to form a quasi-laminar air flow pattern. By application of the ventilation apparatus, the cleanliness of the medical area can be ensured.

### BACKGROUND OF THE INVENTION

(1) Field of the Invention

The invention relates to an interior ventilation apparatus, and more particularly to a local ventilation apparatus that serves in a medical facility, in which the ventilated air is formed as a controlled air flow region to shield a limited sterile medical environment.

(2) Description of the Prior Art

In the midst of various micro pollutants in the atmosphere, quality of the surrounding air is paid more attention by people who care about their health. As well known, various diseases such as the pulmonary tuberculosis, the sever acute respiratory syndrome (SARS), the flu and some respiratory illness can be spread by the air, especially droplet nuclei and suspension aerosols. Such an understanding draws particular alert in medical facilities where always gather sick people. For highly accumulation of patients, densities of the hazardous droplet nuclei and the suspension aerosols in any medical facility would be much higher than those in any other place. Definitely, medical staffs and people in those medical facilities are jeopardous.

To reduce the risk of respiratory infection by the droplet nuclei and the suspension aerosols in the surroundings, appropriate air flow filtration means in the medical facility is necessary, especially in some special locations like the surgery rooms and the intensive care units. At those location, cleanness, distribution, and ventilation volume of the airflow usually need to meet a higher air quality standard. For example, in a Taiwan patent published as M252423, a ventilation apparatus for medical facilities is provided to serve the aforesaid purposes.

In the art, though a substantial cleanliness can be achieved by utilizing ventilation equipment already existing in the market, yet some common shortcomings can still be found in those equipment. These common shortcomings include: requiring a significant piping space under the ceiling, forming corner stagnant areas to accumulate pollution particles, and having a higher relative humidity that will gradually mould the filtration screens and the vent pipes and finally lead to pollute the sterile surroundings. However, by replacing with a fan-filter unit (FFU) to overcome the foregoing problems, a huge expense and possible a space reconsideration are definitely inevitable.

In the M252423, though the apparatus disclosing only the structure change, not the ventilation direction modification, can provide acleanliness, yet following disadvantages are still there. These disadvantages include:

1. generating a turbulent flow with a low-cleanliness which cannot effectively removes the pollutants;

2. lacking control in direction of the pollutants flow; and

3. unable to stabilize the air quality and cleanliness in a certain district.

### SUMMARY OF THE INVENTION

Accordingly, it is an object of the present invention to provide a ventilation apparatus for forming a sterile medical environment, in which a quasi-laminar downward air-flow pattern is introduced to ensure the cleanliness in a application region, in particular a sterile medical district. The ventilation apparatus of the present invention mainly includes a driving unit for circulating the air flow, a filtering unit for filtering dusts and pollutants in the air, a sterilizing unit for eliminating germs in the air so as to assure the air quality and cleanliness. By circulating clean air flow to a certain medical district, a clean and sterile medical environment can then be formed.

The object described above can be achieved by the ventilation apparatus for forming a sterile medical area described below.

### BRIEF DESCRIPTION OF THE DRAWINGS

The present invention will now be specified with reference to its preferred embodiment illustrated in the drawings, in which:

FIG. 1 is a schematic view of a preferred ventilation apparatus for forming a sterile medical area in accordance with the present invention;

FIG. 2 shows a first application of the ventilation apparatus in FIG. 1;

FIG. 3 shows a second application of the ventilation apparatus in FIG. 1;

FIG. 4 shows a third application of the ventilation apparatus in FIG. 1; and

FIG. 5 shows a fourth application of the ventilation apparatus in FIG. 1.

### DESCRIPTION OF THE PREFERRED EMBODIMENT

The invention disclosed herein is directed to a ventilation apparatus for forming a clean air flow apply to sterile medical area. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

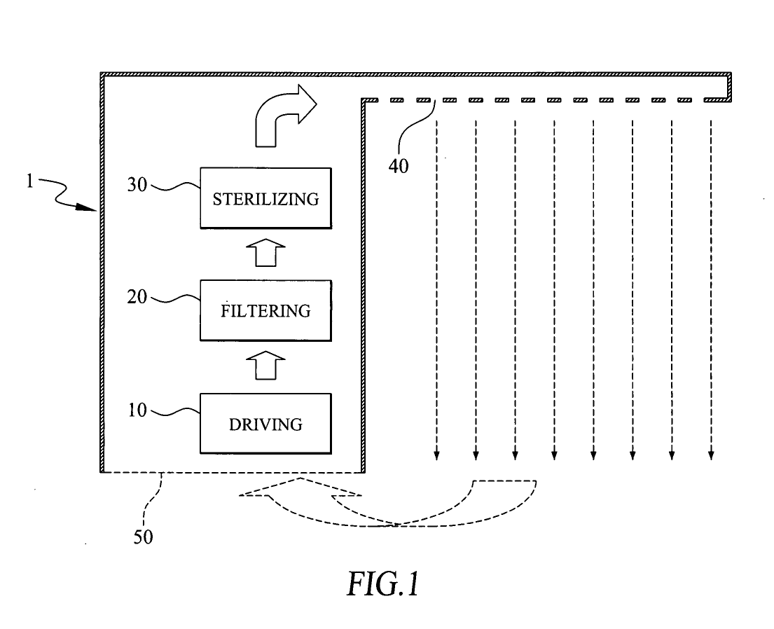

Referring now to FIG. 1, a schematic view of a preferred embodiment of the ventilation apparatus for forming a sterile medical area in accordance with the present invention is shown.

The ventilation apparatus 1 mainly includes an operation module and a transmission module integrated with the operation module but positioned oblique at a 90 degree. The operation module includes a driving unit 10 and a filtering unit 20. Preferably, the operation module can further include a sterilizing unit 30. The driving unit 10 can be a fan device for drawing in the air from a working area (i.e. the medical area) via an air inlet 50. The air is then forwarded to the filtering unit 20 for filtering dusts and various micro pollutants in the air. Generally, the filtering unit 20 includes a high efficiency particulate air (HEPA) filter for cleaning the passing air to a predetermined acceptable standard. The clean or filtered air is then sent directly to the surroundings or led to the sterilizing unit 30 for further treatment. In the sterilizing unit 30, sterilization by ultraviolet ray or by photo catalysis can be used to kill the germs in the air. The air output from the sterilizing unit 30 is then forwarded to the transmission module. The transmission module includes an air outlet 40 having a plurality of small apertures for emitting the clean air into the surroundings. In the present invention, the air outlet 40 can also be an outlet mounted with a HEPA filter. To have an uniform-distributed flow, the transmission module can further include a diffusion structure for diffusing evenly the outgoing clean air flow. Alternatively, the transmission module can have a structure to retard appropriately the flow so that the even-distributed flow can also be obtained.

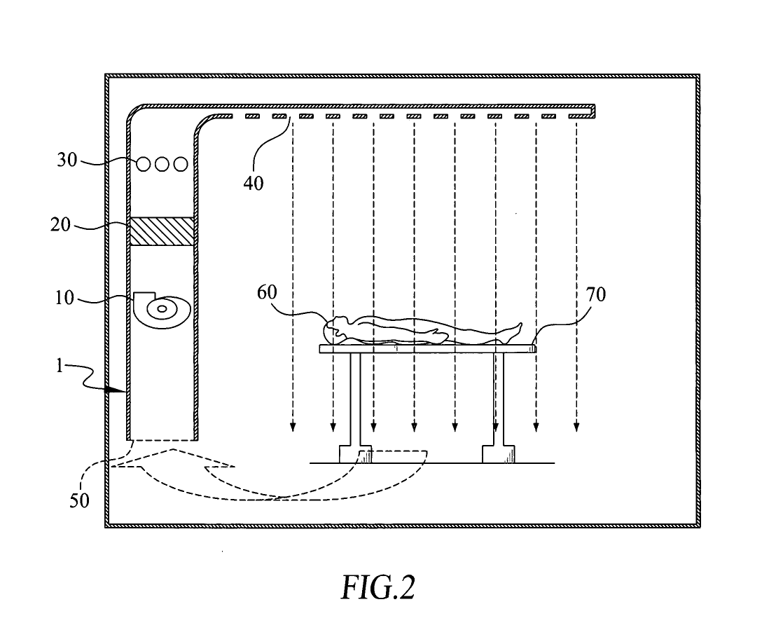

Referring now to FIG. 2, a first application of the ventilation apparatus in accordance with the present invention is shown.

In this embodiment, the target of the concerned sterile medical area can be a patient room, a surgery room or an emergency unit. As shown, the user 60 (i.e. the patient) is lain on a hospital bed 70 which is conditioned by the ventilation apparatus 1 for forming a sterile medical area according to the present invention. The operation module of the ventilation apparatus 1 is mounted close to a head portion of the hospital bed 70 (left hand side portion in FIG. 2), while the transmission module is extended to run along the ceiling by a predetermined length substantially to shield the entire hospital bed 70. Upon such an arrangement, the clean air can flow from the air outlet 40 of the transmission module downward straightly to the floor of the medical area where the hospital bed 70 locates. Thereby, the clean air curtain (shown by dashed lines in FIG. 2) can be formed to shield the entire hospital bed 70 as well as the patient 60. That is to say that a sterile medical area can be formed around the concerned hospital bed 70. When the clean air is going to hit the flow, it can be drawn or suction into the driving unit 10 of the operation module via the air inlet 50 of the apparatus 1 so that a close loop circulation of the air in the sterile medical area can be formed. The air suction into the operation module is then to flow through the driving unit 10, the filtering unit 20, the sterilizing unit 30, and then into the sterile medical area again via the air outlet 40. Definitely, such a close loop air ventilation pattern can ensure the air quality in the sterile medical area and thus possible cross contamination in the medical facility can be reduced to a minimum.

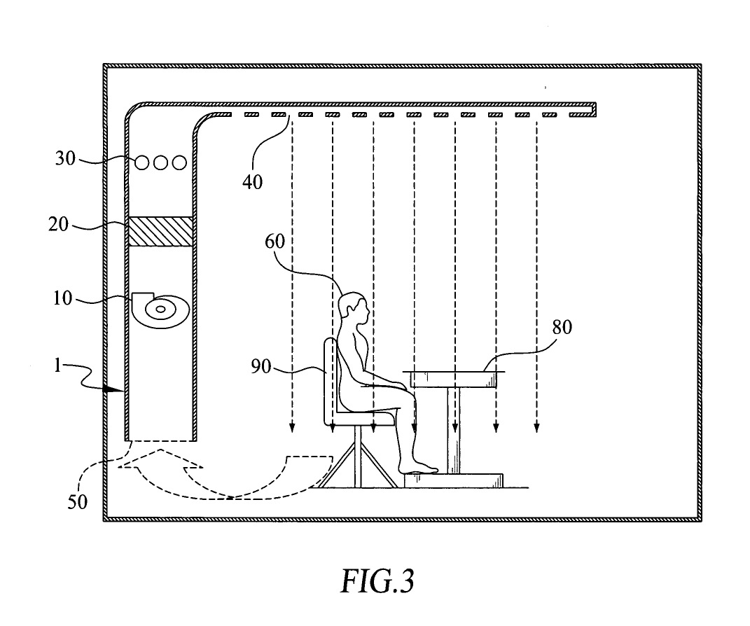

Referring now to FIG. 3, a second application of the ventilation apparatus in accordance with the present invention is shown.

In this embodiment, the target of the concerned sterile medical area can be a clinic room. As shown, when the user 60 (i.e. a possible contaminated patient) is seated in front of a desk 80 for medical advices, the ventilation apparatus 1 of the present invention can be used to form a sterile clinic room where a possible contamination pathway regarding the patient 60 can be better controlled. Also, by utilizing the apparatus 1, clean air in the clinic room can be guaranteed. As shown, the operation module of the ventilation apparatus 1 can be mounted to the wall of the clinic room, while the transmission module is extended along the ceiling by a predetermined length substantially to shield the patient 60, the chair 90, and the desk 80. Upon such an arrangement, the clean and sterilized air can flow from the air outlet 40 of the transmission module downward straightly to the floor of the clinic room to form a sterilized quasi-laminar air flow pattern (shown by dashed lines in FIG. 3). After the clean air flowed through application region, the air suctioned into the ventilation apparatus by the driving unit 10. The driving unit 10 of the operation module via the air inlet 50 of the apparatus 1, form a close loop circulation of the air in the sterile medical area. The air suctioned into the operation module is then to flow through the driving unit 10, the filtering unit 20, the sterilizing unit 30, and then into the sterile medical area again via the air outlet 40. Definitely, such a close loop air ventilation pattern can ensure the air quality in the clinic room, the possible contamination pathway resulting from the patient 60 can be effectively controlled, and possible bacteria from the patient 60 can also be removed by the filtering unit 20 and the sterilizing unit 30 of the apparatus 1. Thereby, the following patients can be prevented from contaminating the same illness the previous patients have.

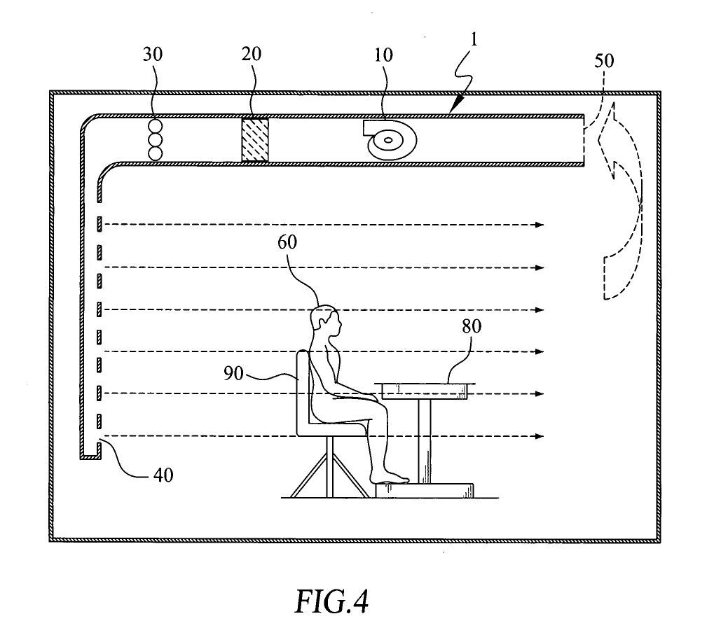

Referring now to FIG. 4, a third application of the ventilation apparatus in accordance with the present invention is shown. It is interesting to note that the air curtain in this embodiment is formed as a horizontal pattern.

In this embodiment, the target of the concerned sterile medical area is also a clinic room. As shown, when the user 60 (i.e. a doctor) is seated in front of a desk 80 to hear a patient's talk, the ventilation apparatus 1 of the present invention can be used to form a sterile clinic room where a possible contamination pathway regarding the patient can be better controlled. Also, by utilizing the apparatus 1, clean air in the clinic room can be guaranteed. As shown, the operation module of the ventilation apparatus 1 can be mounted to the ceiling of the clinic room, while the transmission module is extended downward to run along the wall behind the user 60 by a predetermined length substantially to shield the user 60, the chair 90, and the desk 80. Upon such an arrangement, the clean and sterilized air can flow horizontally from the air outlet 40 of the transmission module rightward straightly so as to form a horizontal sterilized air flow pattern (shown by dashed lines in FIG. 4). When the clean air passes the desk 80, it can besuctioned into the driving unit 10 of the operation module via the air inlet 50 of the apparatus 1 so that a close loop circulation of the air in the sterile medical area can be formed. The air suctioned into the operation module is then to flow through the driving unit 10, the filtering unit 20, the sterilizing unit 30, and then into the sterile medical area again via the air outlet 40. Definitely, such a close loop air ventilation pattern can ensure the air quality in the clinic room and protect the doctor from possible contamination.

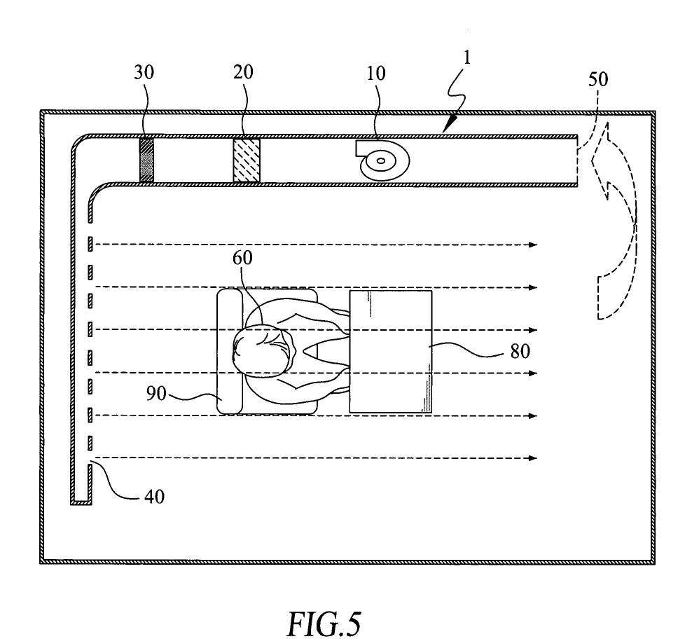

Referring now to FIG. 5, a fourth application of the ventilation apparatus in accordance with the present invention is shown in a top view. In this embodiment, the target of the concerned sterile medical area is also a clinic room. As shown, when the user 60 works in front of a desk 80, the ventilation apparatus 1 of the present invention can be used to form a sterile clinic room isolated from the outside atmosphere. As shown, the operation module of the ventilation apparatus 1 can be mounted horizontally close to the wall of the clinic room, while the transmission module is extended behind the user 60 by a predetermined length substantially to shield the user 60, the chair 90, and the desk 80. Upon such an arrangement, the clean and sterilized air can flow horizontally from the air outlet 40 of the transmission module rightward straightly so as to form a horizontal sterilized air flow (shown by dashed lines in FIG. 5). When the clean air passes the desk 80, it can be turned leftward (in the user's view) and drawn into the driving unit 10 of the operation module via the air inlet 50 of the apparatus 1 so that a close loop circulation of the air in the sterile medical area can be formed. The air suctioned into the operation module is then to flow through the driving unit 10, the filtering unit 20, the sterilizing unit 30, and then into the sterile medical area again via the air outlet 40. Definitely, such a close loop air ventilation pattern can ensure the air quality in the clinic room.

In another aspect of the present invention, the ventilation apparatus 1 can be structured as a unique piece having the operation module and the transmission module 90 angled with the operation module. Also, the operation module can only include the driving unit 10 and the sterilizing unit 30. The driving unit 10 for air suction, via the air outlet 50, from the sterile medical area and forwarding the air to the sterilizing unit 30 can be formed as a fan device. The sterilizing unit 30 can use ultraviolet ray tubes or photo catalysis elements to eliminate micro organisms in the air. The sterilized air leaving the sterilizing unit 30 then flows to the transmission module. The transmission module can now include the filtering unit 20 as described above to filter the dusts and particles in the sterilized air; for example, by a HEPA filter. The air passing the filtering unit 20 is then sent to the air outlet 40 for flowing into the sterile medical area. To uniformly distribute the air flow, the air outlet 40 can further include a diffusion structure for diffusing the outgoing clean air. Alternatively, the air outlet 40 can have a proper structure to retard the flow so that an uniformly distributed flow can be obtained.

In the present invention, a flow pattern of the sterilized air can be a vertical pattern (as shown in FIGS. 1-3) or a horizontal pattern (as shown in FIGS. 4-5.

In the previous description, the location of the filtering unit is designed either to the operation module or to the transmission module. However, no matter what type of the location of the filtering unit is, following advantages are common to either choice. These advantages are as follows.

1. The mounting of the ventilation apparatus in accordance with the present invention is simpler that that of a traditional central air condition system. In the present invention, no further ceiling modification and additional vent pipes are needed.

2. The fan device (i.e. the driving unit) is located inside the ventilation apparatus of the present invention, so that its noise can be reduced to a minimum.

3. Additional devices such as the ultraviolet ray tubes or the photo catalysis devices can be installed into the ventilation apparatus in accordance with the present invention, so that the air quality in sterilization can be superior to that in a conventional FFU.

While the present invention has been particularly shown and described with reference to a preferred embodiment, it will be understood by those skilled in the art that various changes in form and detail may be without departing from the spirit and scope of the present invention.

I claim:

1. A ventilation apparatus for forming a clean and sterile medical application, comprising:
an operation module, further comprising;
a driving unit for air suction from the application clean environment via an air inlet and for forwarding the air;
a filtering unit for filtering the air forwarded by the driving unit; and
a sterilizing unit for eliminating micro organisms in the air; and
a transmission module, further comprising an air outlet, connected with the operation module perpendicularly, receiving the air sent from the operation module and then forwarding the air to the sterile medical area via the air outlet;
wherein the air in the sterile medical area is sucked into the operation module via the air inlet so as to form a close loop ventilation of the air.

2. The ventilation apparatus for forming a sterile medical area according to claim 1, wherein said driving unit is a fan device.

3. The ventilation apparatus for forming a sterile medical area according to claim 1, wherein said filtering unit is a high efficiency particulate air filter.

4. The ventilation apparatus for forming a sterile medical area according to claim 1, wherein said sterilizing unit is one selected from a group of ultraviolet ray tubes and photo catalysis elements.

5. The ventilation apparatus for forming a sterile medical area according to claim 1, wherein said transmission module is mounted to a ceiling of said sterile medical area and a flow pattern of said air is one selected from a group of a vertical pattern and a horizontal pattern.

6. The ventilation apparatus for forming a sterile medical area according to claim 1, wherein said transmission module is mounted close to a wall of said sterile medical area so as to have said air leaving said air outlet flow in a direction away from the wall.

7. The ventilation apparatus for forming a sterile medical area according to claim 1, wherein said air outlet further includes a diffusion structure for evenly distributing said air.

8. A ventilation apparatus for forming a sterile medical area, comprising:
an operation module, further comprising;
a driving unit for sucking air from the sterile medical area via an air inlet and for forwarding the air; and
a sterilizing unit for eliminating micro organisms in the air; and
a transmission module, connected with the operation module perpendicularly, receiving the air sent from the operation module and then forwarding the air to the sterile medical area via the air outlet, further comprising:
a filtering unit for filtering the air forwarded by the operation module; and
an air outlet for evenly distributing the air to the sterile medical area;
wherein the air in the sterile medical area is sucked into the operation module via the air inlet so as to form a close loop ventilation of the air.

9. The ventilation apparatus for forming a sterile medical area according to claim 8, wherein said driving unit is a fan device.

10. The ventilation apparatus for forming a sterile medical area according to claim 8, wherein said filtering unit is a high efficiency particulate air filter.

11. The ventilation apparatus for forming a sterile medical area according to claim 8, wherein said sterilizing unit is one selected from a group of ultraviolet ray tubes and photo catalysis elements.

12. The ventilation apparatus for forming a sterile medical area according to claim 8, wherein said transmission module is mounted to a ceiling of said sterile medical area and a flow pattern of said air is one selected from a group of a vertical pattern and a horizontal pattern.

13. The ventilation apparatus for forming a sterile medical area according to claim 8, wherein said transmission module is mounted close to a wall of said sterile medical area so as to have said air leaving said air outlet flow in a direction away from the wall.

14. The ventilation apparatus for forming a sterile medical area according to claim 8, wherein said air outlet further includes a diffusion structure for uniformly distributing said air.
